(19) United States
(12) Patent Application Publication
(10) Pub. No.: US 2006/0185797 A1
(43) Pub. Date: Aug. 24, 2006

(54) Heat sealing and slitting blade with variable radius cutting tip

(75) Inventors: Robert Lauzon, Montreal (CA); Pierre Papineau, Bainsville (CA)

Correspondence Address: DAVID M. CARTER;CARTER SCHNEDLER & MONTEITH, P.A., 56 CENTRAL AVENUE, SUITE 101, P.O. BOX 2985, ASHVILLE, NC, 28802, US

(73) Assignee: Glopak Inc., Montreal (CA)

(21) Appl. No.: 11/256,318

(22) Filed: Oct. 21, 2005

(30) Foreign Application Priority Data
Feb. 23, 2005 (CA) 2,498,011

(51) Int. Cl. B32B 38/04

(52) U.S. Cl. 156/515

(57) ABSTRACT

A heat sealing and slitting blade for slit sealing overlaid sheet of thermoplastic film material. The film material to be slit and sealed has at least two portions of different thickness. The blade has an elongated cutting tip having at least two different transverse radius sections therealong with a larger one of the radius sections being adapted to seal a thicker one of the two portions of different thickness to improve seal integrity along the predetermined length.

### TECHNICAL FIELD

The present invention relates to a heat sealing and slitting blade for slit sealing thermoplastic film material along a predetermined length and wherein the film material has at least two portions of different thickness, and the cutting tip of the blade has at least two different transverse radius sections therealong.

### BACKGROUND ART

When fabricating bags from polyethylene film material, often the bags are provided with a gusset or zip lock and when the folded plastic film is sealed and cut by a heated cutting knife, the seal integrity is affected in transition areas along the slit edge where the material is. When slitting and simultaneously melting the plastic material in the thicker areas more molten plastic material is present and such attracts the molten plastic material in the immediate adjacent area which is thinner (less molten plastic). Accordingly, the immediate area that is thinner is deprived of a molten plastic by capillary attraction and often results in the formation of holes creating air leaks, particularly when the gusseted end of the bag is open under pressure before the bag receives a product therein. This is particularly so with bread bags. It is important with bread bags to maintain the bag substantially sealed to prevent air from drying out the bread inside the bag. This is also the case when a zip lock is welded across the bag and the seal needs to be effected along the outer ends of the zip lock where it is fused to the edge of the film material. Because the zip locks are constructed of fairly thick plastic material, the problem again arises of having more molten material at the end of the zip lock creating a capillary effect to draw in molten plastic adjacent thereto and into the thicker area, thereby creating a weak seal with pin holes adjacent the zip lock. There is therefore a need to overcome these problems and to provide seals that have integrity throughout the seam.

### SUMMARY OF INVENTION

It is a feature of the present invention to provide a heat sealing and slitting blade which substantially overcomes the above-mentioned disadvantages of the prior art.

Another feature of the present invention is to provide a heat sealing and slitting blade wherein the cutting tip of the blade has at least two different transverse radius sections therealong.

Another feature of the present invention is to provide a heat sealing and slitting blade in combination with a bag forming machine for forming polyethylene plastic bags which may have a gusseted section or a zip lock section and which substantially overcomes the above-mentioned disadvantage of the prior art.

According to a broad aspect of the present invention there is provided a heat sealing and slitting blade for slit sealing overlaid sheet of thermoplastic film material along a predetermined length to form an edge seal and wherein the film material has at least two portions of different thickness along the seal. The blade has an elongated cutting tip having at least two different transverse radius sections therealong with a larger one of the radius sections being adapted to seal a thicker one of the two portions of different thickness to improve seal integrity along the predetermined length.

According to a further broad aspect of the present invention the blade is provided in combination with a bag forming machine and wherein the thermoplastic film material is a folded polyethylene film sheet folded to form gusseted bags. The gusseted film portion is thicker and usually formed by four film plies. The thinner one of the two portions is a two ply film portion. A one ply lip area may also be formed at the outer end of the bag.

According to a further broad aspect of the present invention the polyethylene film material is folded to form a bag having a zip lock end portion.

### BRIEF DESCRIPTION OF DRAWINGS

A preferred embodiment of the present invention will now be described with reference to the accompanying drawings in which:

FIG. 1 is fragmented perspective view showing the construction of the heat sealing and slitting blade of the present invention;

FIG. 2 is a transverse cross-section view of the heat sealing and slitting blade shown in FIG. 1;

FIG. 3 is a bottom view of the heat sealing and slitting blade showing the elongated cutting tip having at least two different transverse radius sections;

FIG. 4A is a simplified fragmented section view showing a seal being formed in a thicker folded film portion by the larger radius cutting tip;

FIG. 4B is a view similar to FIG. 4A but showing a smaller radius cutting tip forming a seal between two plies of polyethylene film material;

FIG. 5A is a bottom view of the heat sealing and slitting blade showing the cutting tip along the entire length of the blade;

FIG. 5B is a fragmented plan view showing a folded film sheet forming a gusseted bag having a transverse seal formed thereacross by the sealing blade of FIG. 5A;

FIG. 5C is a view similar to FIG. 5B but showing a shorter length gusseted bag being formed by the same blade of FIG. 5A;

FIG. 6 is a fragmented plan view showing a corner portion of a plastic film bag formed with a zip lock;

FIG. 7 is a simplified block diagram showing gusseted bags formed with the heat sealing and slitting blade of the present invention;

FIG. 8 is a section view through an edge seal of a gusseted bag formed with the prior art sealing and slitting blades; and

FIG. 9 is a graph showing the air pressure resistance of gusseted bags formed with uniform radius blades and a variable radius blade constructed in accordance with the present invention.

### DESCRIPTION OF PREFERRED EMBODIMENTS

Referring now to the drawings and more particularly to FIG. 1, there is shown generally at 10 the heat sealing and slitting blade of the present invention. The blade consists of an elongated steel body 11 having a top cavity 12 to receive in close contact therein a resistive heating element 13 whereby to transmit heat to the steel body. The lower part of the steel body defines a blade 9 having an elongated cutting tip 14 provided with a sharp edge whereby to simultaneously heat and slit through overlaid plastic film sheets, as will be described hereinafter, to operate the sheets into bags and form edge seals.

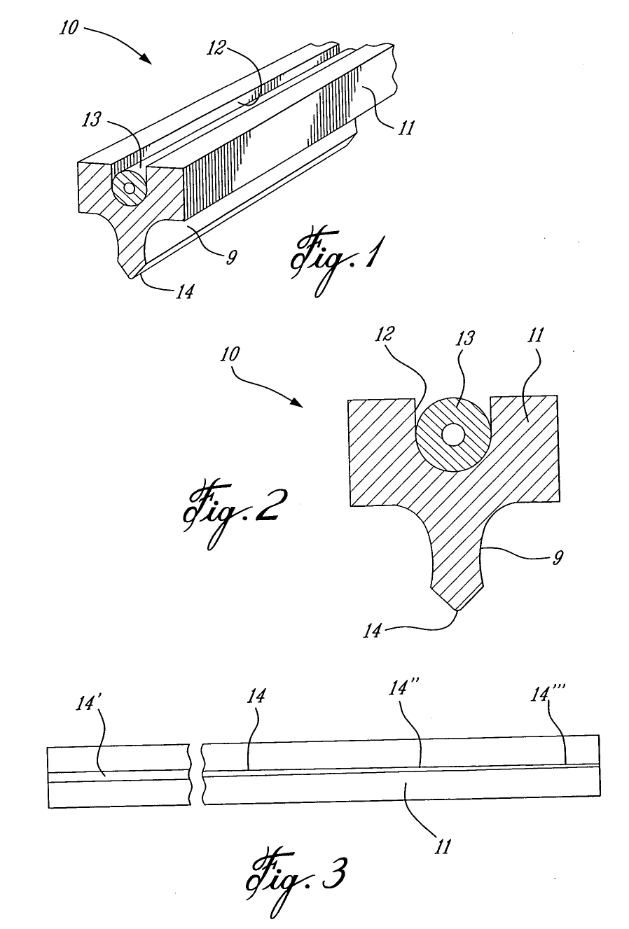

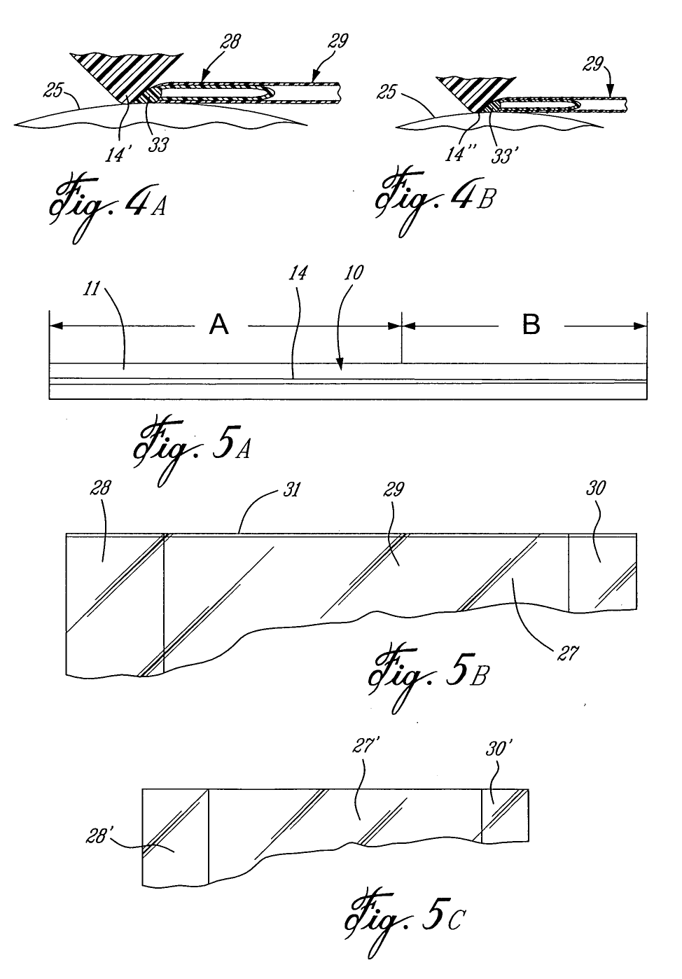

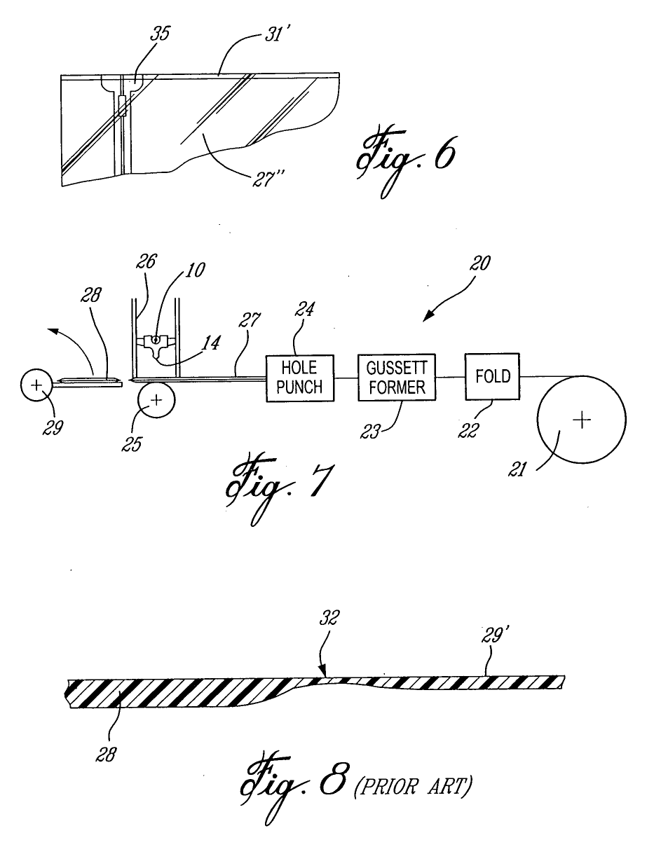

The novelty in the heat sealing and slitting blade 10 of the preset invention is illustrated in FIG. 3 and it resides in the elongated cutting tip 14 having at least two different transverse radius sections 14′ and 14″ with radius section 14′ being larger than radius section 14″. In fact, as hereinshown the radius section tapers gradually from the larger radius section 14′ to the smaller radius section 14″ and may level off in a constant narrow section 14′″. The purpose for this cutting tip having different transverse radius sections therealong will become evident from the continuing description with respect to FIGS. 4A, 4B and 5A to 5C. However, before doing so, reference is now made to FIG. 7 which shows a bag forming machine 20 for forming thermoplastic gusseted bags.

The bag forming machine 20 consists of a supply roll 21 of polyethylene sheet material which is drawn through a folding mechanism 22 to provide a folded film sheet. The folded end of the sheet is then drawn through a gusset former 23 wherein an inner fold is formed in a portion thereof such that that portion has four overlaid plies of film material. If a lip is required on the bag, then the folded-over sheet portion is shorter than the under sheet thereby exposing a film sheet portion and it may be drawn through a hole punch 24 to form holes in the lip to engage wicket pins which holds stacks of bags. The folded film is then drawn over a Teflon coated support roll 25 disposed in longitudinal alignment with the cutting tip 14 of the heat sealing and slitting blade 10 which is secured to a reciprocating carriage mechanism 26 to strike the blade at time intervals against the folded film sheet 27 thereunder whereby to slit and form opposed longitudinal seals across the folded film sheet to form gusseted bags 28, with each bag 28 being ejected on a support turret 29 to transfer the gusseted bag onto a stack (not shown). Such a machine is well known in the art.

As shown in FIG. 5B, the folded film sheet 27 is therefore provided with a folded gusseted portion 28 at one end thereof, a two-ply bag portion 29 and a one-ply lip portion 30. The folded gusseted portion, as above mentioned, has a four-ply gusseted portion 28 and therefore the film material in the folded gusseted portion 28 is twice as thick as that in the two-ply bag portion 29 and four times as thick as the single ply portion. If the seal 31 as herein illustrated was to be formed by a heat sealing and slitting blade of the prior art, then when the plastic is melted there is obviously more molten plastic in the folded gusset portion 28 than in the two-ply bag portion 29. As shown in FIG. 8, because there is more plastic material in the gusset portion 28, the molten plastic in that portion will have a tendency of drawing plastic material from a region immediately adjacent to it by capillary attraction therefore drawing material from the two-ply bag portion 29′ which is twice as thin. This creates a weakened area 32, as herein illustrated, and this weakened area 32 may have holes therealong. In any event, when the gusseted bag is opened under pressure or a material is inserted therein, tension is drawn on the weakened portion 32 and causes it to perforate at its weakest parts therealong or case holes therein to enlarge. This permits air to infiltrate the bag and if the gusseted bag is utilized for packaging foodstuff that needs to be shielded from ambient air, then the air may have a drying effect on the foodstuff particularly a bread product if the bag is used for packaging bread.

In order to resolve the problem of the prior art as illustrated FIG. 8, the elongated cutting tip 14, as shown in FIGS. 3 and 5A, is provided with at least two different transverse radius sections therealong and as shown in FIG. 5A, the blade has a larger radius along section A. As can be seen, section A extends well beyond the folded gusseted portion 38 and into the two-ply portion 29. Accordingly, because the radius is larger, as illustrated in FIG. 4A, the blade tip 14 exposes more heated metal surface area to the folded gusseted film portion as it is thicker thereby creating sufficient melted plastic material to form a seal bead 33 as shown in FIG. 4A. Because this larger radius extends well into the two-ply bag portion 29 there is sufficient molten material in those sections and the seal 31 will not be affected by capillary attraction by the thicker portion 28 of the bag and will not create a weakened zone 32, as illustrated in FIG. 8. At a predetermined location along the cutting tip, the diameter reduces into the second portion of the second ply bag portion 29 and into the lip portion 30, which is a single ply, if this is provided. In these portions, less heat is required to form the seal and less tip surface area is in contact with the films. It is pointed out that the elongated cutting tip may have a progressive taper along its entire length to achieve the results of the present invention and namely of achieving a seal which has improved integrity along its entire length and which eliminates weakened zones at the junctions of the thicker and thinner portions, designated by reference numeral 32 in FIG. 8.

As previously described, the larger radius portion of the cutting tip extends well into the two-ply bag portion 29 and this also accommodates gusseted bags of different lengths on the machine 20, as illustrated in FIG. 5. As shown in FIG. 5, shorter gusseted bags 27′ may be processed. The shorter bags, however, have their folded gusseted portion 28′ still disposed within the larger radius portion A of the cutting tip of the blade 10. Accordingly, it is not necessary to change the blade as the folded gusseted portion 28′ of the shorter bags still lies within the large tip radius portion of the blade cutting tip 14.

FIG. 6 shows another advantage of the use of this type of blade but wherein the thickness of the plastic material along the cutting edge 31′ differs due to the fact that a zip lock end 35 needs to be secured and welded to the seal edge 31′. Accordingly, the zip lock end 35 provides a thicker plastic material section which needs to be melted and sealed with the folded plastic film bag 27″. Accordingly, the variable cutting tip surface area of the blade of the present invention provides more heat distribution in film portions which are thicker than other portions and prevents the formation of weak or punctured seals at the junctions between the different film thicknesses.

Typically, the film material for forming plastic bags is a polyethylene film material having a thickness in the range of from about 0.0005 to 0.002 inches. The smaller radius section of the cutting tip of the blade is typically 0.031 inch and progresses to the larger radius section to about 0.063 inch. Preferably, the larger radius section is 0.047 inch when forming gusseted bags having a four-film layer folded gusset. The sealing and slitting blade is heated to a normal sealing temperature of about 930° F.

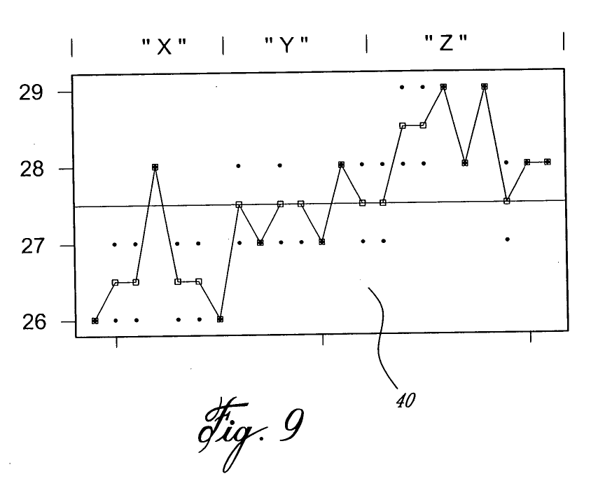

With reference now to FIG. 9, there is shown generally at 40, a graph which shows air pressure resistance tests in gusseted bags constructed with three different heat sealing and slitting blades. The bags were formed under the same operating conditions with the same plastic film material. Section X of the graph represents the characteristics of the air pressure test of a gusseted bag formed with a heat sealing and slitting blade having a uniform radius of 0.031 inch therealong. Section Y of the graph illustrates the characteristics of a gusseted bag formed with a heat sealing and slitting blade having a uniform radius of 0.047 inch. However, when the gusseted bag was formed with the variable radius heat sealing and slitting blade of the present invention, with the radius varying between 0.031 and 0.047, it can be seen that the air pressure resistance test was greatly enhanced. The test consists of closing the open-mouth end of the bag and inflating the bag with air under pressure until the bag bursts or punctures. With the blade of the present invention more often the plastic wall of the bags stretched and punctured before the seals which are thicker and integral throughout.

It is within the ambit of the present invention to cover any obvious modifications of the preferred embodiment described herein provided such modifications fall within the scope of the appended claims. It is also pointed out that for ease of illustration the elongated cutting tip has been exaggerated to show that the tip has a variable transverse radius section.

We claim:

1. A heat sealing and slitting blade for slit sealing overlaid sheets of thermoplastic film material along a predetermined length wherein said overlaid sheets of film material having at least two portions of different thickness along said length, said blade having an elongated cutting tip having at least two different transverse radius sections therealong with a larger one of said radius sections being adapted to seal a thicker one of said two portions of different thickness to improve seal integrity along said predetermined length.

2. A heat sealing and slitting blade as claimed in claim 1 wherein said larger radius section of said cutting tip is longer than said thicker portion of said film material to be sealed.

3. A heat sealing and slitting blade as claimed in claim 2 wherein said larger radius section merges progressively into a smaller one of said radius sections.

4. A heat sealing and slitting blade as claimed in claim 3 in combination with a bag forming machine and wherein said thermoplastic film material is a folded polyethylene film sheet folded to form gusseted bags, said thicker one of said two portions being a gusset film portion having four film plies, a thinner one of said two portions being a two-ply film portion.

5. A heat sealing and slitting blade as claimed in claim 4 wherein said larger radius section extends beyond a seal junction between said four film ply portion and said two film ply portion, said larger radius section providing more cutting tip surface area and more heat distribution to said gusset film portion and along said seal junction.

6. A heat sealing and slitting blade as claimed in claim 5 wherein said folded polyethylene film material has a third single ply lip portion extend beyond a free end of said two-ply film portion.

7. A heat sealing and slitting blade as claimed in claim 4 wherein said polyethylene film material has a thickness in the range of from about 0.0005 to 0.002 inches, said smaller radius section being 0.031 inch and progressing to said larger radius section to about 0.063 inch.

8. A heat sealing and slitting blade as claimed in claim 7 wherein said larger radius section is preferably 0.047 inch.

9. A heat sealing and slitting blade as claimed in claim 4 wherein said bag forming machine has a Teflon coated support roll disposed in longitudinal alignment with said cutting tip and disposed below said folded polyethylene film material, said sealing and slitting blade being a steel blade having a resistive heating element secured thereto to heat said blade to a desired temperature, said sealing and slitting blade being secured to a reciprocating mechanism.

10. A heat sealing and slitting blade as claimed in claim 9 wherein said sealing and slitting blade is heated to a temperature of about 930° F. by said resistive heating element.

11. A heat sealing and slitting blade as claimed in claim 6 wherein said larger radius section is of sufficient length to extend across a gusset film portion of longer bags having a longer gusset film portion.

12. A heat sealing and slitting blade as claimed in claim 11 wherein said gusset film portion is formed by effecting an inner fold in a folded side edge of said film sheet drawn from a supply roll of film material.

13. A heat sealing and slitting blade as claimed in claim 3 in combination with a bag forming machine and wherein said thermoplastic film material is a polyethylene film material, said thicker one of said two portions being a zip-lock end portion.
